(19) United States
(12) Patent Application Publication
(10) Pub. No.: US 2012/0248758 A1
(43) Pub. Date: Oct. 4, 2012

(54) SECURITY DOCUMENT

(75) Inventors: Karen O'Donoghue, Loughton (GB); Ruth Ryan, High Heaton (GB); Andrew Benniston, Newcastle (GB); Anthony Harriman, Newcastle (GB); Steve Rimmer, West Yorkshire (GB); Prodip Sarker, Sheffield (GB); Linda Swanson, Sheffield (GB)

(73) Assignee: The Governor & Company of the Bank of England, London (GB)

(21) Appl. No.: 13/504,768

(22) PCT Filed: Oct. 27, 2010
(86) PCT No.: PCT/GB2010/051800

§ 371 Date: Jun. 20, 2012

(30) Foreign Application Priority Data
Oct. 29, 2009 (GB) 0918939.0

(51) Int. Cl. B42D 15/00

(52) U.S. Cl. 283/85

(57) ABSTRACT

There is provided a security document (10) bearing an image (16) associated with an active substance, wherein the active substance is responsive to tactile pressure (18) in the range 0.01-1O MPa to alter the appearance of the image particularly when viewed under ultraviolet radiation (14). The active substance can be incorporated in an ink forming at least part of the image, in one or more layers associated with or beneath the image, or incorporated within a polymer, or adhesive associated with the image. The active substance comprises at least one of the following: organic or inorganic dye or dyes, chromophore(s), multi-chromophore(s), lumiphore(s). A layer incorporates a UV filter capable of being rendered inoperative in response to pressure, such that tactile pressure thins this layer so that the UV are no longer blocked and reach the lumiphore layer.

### FIELD OF THE INVENTION

This invention relates to a security document incorporating an image used to determine the authenticity of the document.

### BACKGROUND TO THE INVENTION

Security documents incorporate a variety of features to prevent the documents being forged and to assist with determining their authenticity. Some of these features are designed to be visible under synthetic radiation, such as ultraviolet radiation, and in particular units that emit ultraviolet radiation are used for checking banknotes. Many of the existing security features are well known and there is a continual need to adopt new features to ensure that the properties of authentic banknotes cannot be duplicated or simulated in a way that prevents authentication of genuine banknotes. Ideally any new features need to be assessable using existing detection equipment. It is an aim of the present invention to provide a new security feature used on security documents.

### SUMMARY OF THE INVENTION

In accordance with one aspect of the present invention, there is provided a security document bearing an image associated with an active substance, wherein the active substance is responsive to pressure to temporarily alter the appearance of the image when viewed under synthetic radiation, such as ultraviolet radiation. Thus the document when viewed initially depicts the image with a first appearance, and when pressure is applied, the image changes to a second appearance, the image reverting to the first appearance once the pressure is removed. This gives a readily visible change to the image when pressure is applied which allows the user to determine the authenticity of the security document.

Preferably the change in appearance lasts for 5 minutes to 0.1 seconds after the pressure is removed, and more preferably lasts 60 seconds to 1 second. A fast reversible change is desirable so that documents quickly revert to their normal appearance once authenticity has been determined.

Desirably the active substance emits radiation and the emitted radiation may change wavelength as pressure is applied so as to alter the appearance of the image. Emission of radiation is in response to the substance preferably having a broad strong absorption peak in the ultraviolet UV region and a high extinction coefficient in the ultraviolet, typically around 365 nm and particularly over the uvₐ and uv_{b} where uvₐ has a frequency range of 400-315 nm and uv_{b} has a frequency range of 280-315 nm.

Typically the synthetic radiation is ultraviolet radiation, preferably emitted by a broad spectrum UV lamp with a strong emission peak around 365 nm. Devices emitting ultraviolet radiation are already used to identify other features on security documents and by causing changes in the image to occur when illuminated under ultraviolet radiation, authenticity can be determined.

Preferably the active substance is responsive to pressure in the range 0.01-10 MPa, more preferably 0.1-1.0 MPa, which is equivalent to the pressure applied by a human digit, such as a finger or thumb. Typically this tactile pressure will be generated by pressing or rubbing the image on a security document with a finger or thumb.

Desirably the response of the active substance is completely reversible with the image reverting to its first appearance once pressure is removed. This allows pressure to be applied to determine authenticity as many times as needed over the life of a security document.

The active substance may be incorporated in an ink forming at least part of the image.

The active substance may be incorporated in a substrate, such as paper, polymer, or hybrid substrate of both paper and polymer or be associated with a plurality of communicating layers.

Preferably the active substance is dispersed in a polymer, thixotropic material or adhesive.

The active substance may be incorporated in fibres, strands, embedded thread, windowed thread, or tape within a substrate, such as paper, forming part of the document of value.

The active substance may be incorporated in a patch applied to a substrate.

If desired, a compressible layer may be associated with the active substance, the active substance responsive to compression of the layer to alter the appearance of the image.

The compressible layer may be a patch encapsulating a flowable substance, such as a gel, incorporating an ultraviolet absorber.

The active substance may be associated with one, two, three or more communicating layers disposed above a substrate.

The layer or layers may incorporate a UV filter capable of being rendered inoperative in response to pressure. This allows UV radiation to be blocked and prevented from irradiating an active substance until pressure is applied.

The active substance may comprise at least one of the following: an organic or inorganic dye or dyes, or pigments, chromophore(s), multi-chromophore(s), lumiphore(s).

The active substance may be able to form excimers and be responsive to pressure to alter the number of excimers, and so alter the emission characteristics of the substance.

The invention will now be described by way of example with reference to the accompanying drawings in which:

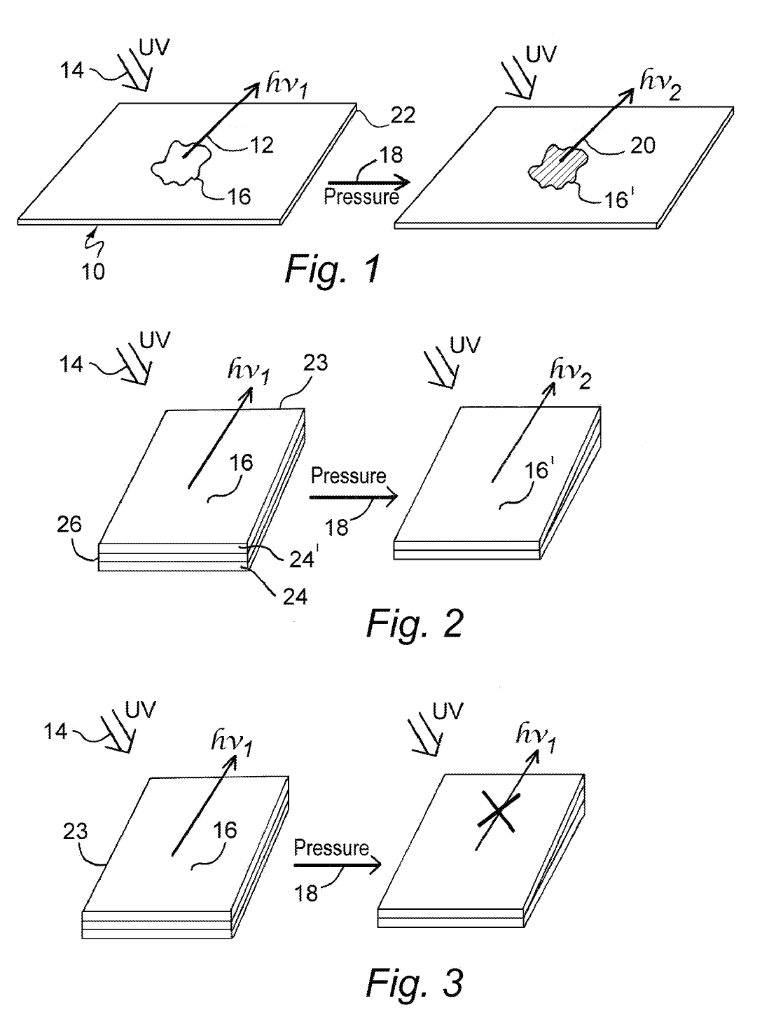

FIG. 1 is a schematic diagram of a document of value according to a first embodiment of the invention; and

FIGS. 2 to 4 are schematic diagrams of patches, typically applied to a document of value, according to other embodiments of the invention; and

FIG. 5 is a schematic diagram of a further embodiment.

### DESCRIPTION

FIGS. 1 to 5 show different embodiments of the invention, all of which exhibit the same general characteristics of an image changing visual appearance as pressure is applied, the image returning to its original appearance after the pressure is removed.

Document of value 10 in FIG. 1 is typically a flexible paper-based document such as a banknote or bond and includes an active substance which is thermodynamically stable at everyday temperatures encountered by such documents, typically temperatures in the range −5 to 40° C., and which produces radiation 12 at a given wavelength hv₁ when exposed to ultraviolet radiation 14. The emitted radiation can be generated through any mechanism, typically luminescence such as fluorescence or phosphorescence. The active substance is associated with an image 16 on the document of value with the image or pattern 16 having a first appearance determined by the emission wavelength of the active substance in response to the ultraviolet radiation. When tactile pressure 18 in the range 0.01-10 MPa is applied by pressing the image 16, this also applies pressure to the active substance which responds by altering its emission wavelength. This alters the appearance of the image or pattern as the appearance is dependent on the wavelength 20 emitted by the active substance. Typically the alteration in wavelength, and consequently image, is visible for a short period of time after the pressure is removed. Thus the image 16 can be pressed, the finger applying the pressure removed, and the change in appearance seen before the active substance returns to its original emission state, typically within 5 minutes to 0.1 seconds, and the previous image is restored.

A variety of different active substances with different properties can be used and can be placed on or incorporated into the document of value in a number of different ways to produce a temporary visual change as pressure is applied. The image can be achieved by a pattern which extends across the whole of the document of value, or be in a specific area as shown in FIG. 1, or can be a strip, patch or other defined area.

The image can be visible or invisible initially as long as it changes appearance when pressure is applied. Protective layers or coatings are associated with the responsive material wherever this is necessary to maintain the characteristics of the active substance.

In the embodiment shown in FIG. 1, a luminescent dye that forms excimers is incorporated into banknote paper 22, for example as an embedded thread or tape, or by adding fibres during the paper making process. Alternatively it may be incorporated in the polymer or adhesive of a stripe or patch on the surface of the note, for example a foil patch, or incorporated in an ink which is printed on to the surface of the banknote. Under ultraviolet radiation from a broad spectrum UV source with a strong emission peak at 365 nm, the dye absorbs UV radiation and emits radiation at a given wavelength or over a restricted wavelength range. It is formulated to allow a proportion of the molecules within the dye to form excimers (excited dimers); the excimers emit radiation at a different wavelength to the monomers or single molecules in the dye. When pressure 18 is applied, the proportion of excimers changes, altering the ratio of the radiation emitted by the single molecules relative to the radiation emitted by the excimers. Thus a finger or thumb applying pressure will cause an altered emission spectrum in and around the area to which pressure is applied, most readily seen as a change in the appearance (i.e colour perceived by the viewer) of the image 16 as the finger or thumb is removed. The altered emission spectrum will gradually die away over 0.1-10 seconds as the normal ratio of excimers to monomers is re-established.

The change in emission spectrum upon removal of pressure is reversible indefinitely.

With dyes suitable for use in the invention, the wavelength of light emitted under ultraviolet radiation is generally well separated from the wavelength emitted when the ratio of excimers is changed. As such the colour change can be selected over a fairly large range, dependent on the dye or combination of dyes used to give a distinct visual colour change. The eye is particularly sensitive to red and green, so for example an initial monomer response showing green radiation is selected, with the excimer emitting in the lower energy red part of the spectrum.

Alternatively a dye may be selected that emits in the non-visible range, with visible luminescence under ultraviolet radiation induced with the application of pressure.

In another preferred embodiment, the active substance such as a luminescent dye is dispersed in a thixotropic material before being applied to the document of value as shown in FIG. 1, again in a suitable pattern or other image. The dye is of a type where the luminescent intensity is dependent on the local viscosity with the luminescence being extremely low when the local viscosity approaches a near fluid state but the intensity increasing dramatically upon the local viscosity becoming solid. The thixotropic material shows a time-dependent change in viscosity with the longer the material undergoes shear stress, the lower its viscosity. Applying pressure makes the thixotropic material become more fluid and so changes the local viscosity around the dispersed dye molecules. The change in viscosity causes the luminescence to disappear, with luminescence reappearing once the thixotropic material returns to its normal state after the pressure is removed. Thus a document of value incorporating a dye dispersed in a thixotropic material shows luminescence under ultraviolet radiation, and when the image on the document of value has pressure applied, by rubbing or holding a finger against it, the luminescence is seen to fade away, reappearing some seconds after the pressure is removed. If necessary, a protective layer is applied over the top of the document of value to ensure that the thixotropic material and the dispersed dye are protected.

Another embodiment uses a fluorescent dye dispersed within a material where the fluorescence is switched on/off by the presence of an acid. This is achieved by an acid group being encapsulated in a reverse micelle structure. Under normal conditions the acid is contained within the reverse micelle group and does not affect the luminescent dye, such that the luminescence is visible under ultraviolet radiation. When pressure is applied to the document of value over the area where luminescence occurs, this disrupts the micelle structure. The disrupted micelle releases the acid which protonates the dye to switch off the luminescence. The system is designed such that once the pressure is removed, the protons of the acids are reabsorbed by the reformed reversible micelle structure, with luminescence then switching back on. A similar principle can be employed to release an alternative luminescence quencher.

Examples 2, 3 and 4 show square patches 23 made of two or more polymer layers or resiliently compressible sheets 24, 24′ which can, if desired, be separated by a compressible layer 26. The two layers contain active substances that are mutually influential when in close contact. For example, the two layers 24, 24′ can contain respective chromophores or multi-chromophores that have good spectral overlap and undergo energy transfer when in close contact so as to alter the emission spectrum at the deformation site where pressure is applied. Pressure causes energy transfer that results in emission of a different wavelength. Certain active substances will change their emission radiation as the matrix they are embedded within stretches as the pressure is applied.

The patches 23 can be of any shape or design, and can be adhered to or incorporated in the banknote substrate or paper. The patch 23 is visible as one image or colour 16 under ultraviolet light 14, changing to another image or colour 16′ as pressure is applied.

The chromophore used can be a transition or lanthanide metal complex, or an organic substance, or an organic substance incorporating a transition or lanthanide metal complex. The chromophores are typically supported in a polymer, co-polymer or other suitable matrix or ink vehicle, either by being dispersed, directly embedded or covalently attached to a polymer layer.

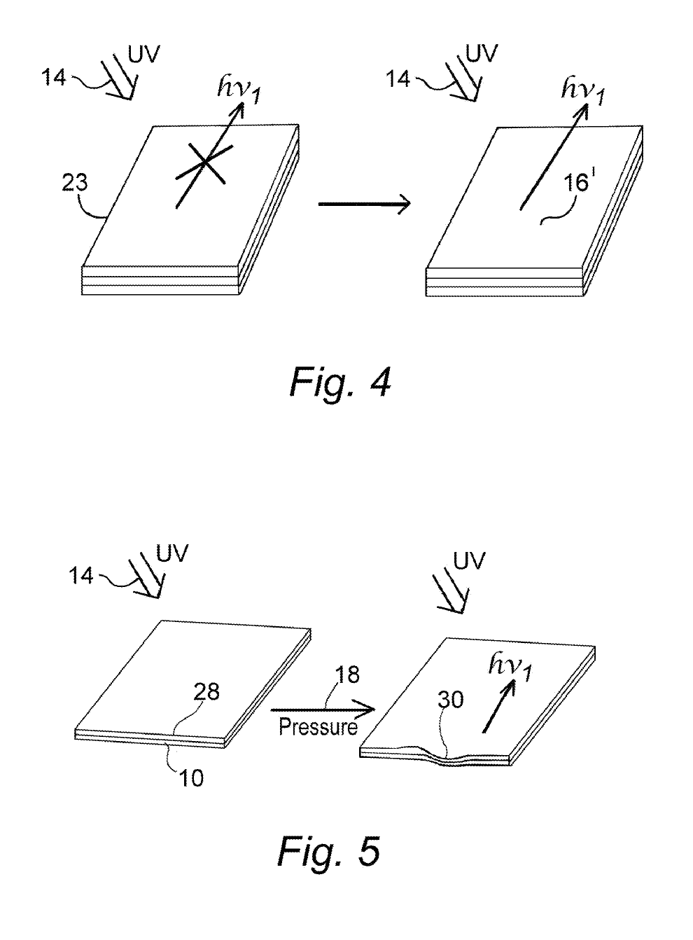

Alternatively one layer in the patch can incorporate an efficient quencher, such that luminescence is extinguished or reduced when pressure is applied, see FIG. 3, and the image is no longer visible. Quenching can be achieved by an electron transfer process between the two active substances that occurs when pressure is applied. Lastly, as in FIG. 4, compression of one or more layers can result in luminescence being switched on and thus a colour change observed.

In another embodiment, change in appearance with pressure is achieved using liquid crystalline materials. A fluorescent molecule highly susceptible to excimer formation, such as a covalently-linked dimer, is dispersed in a liquid crystalline phase or corrugated polymer which is applied to or incorporated in a document of value. Under ultraviolet radiation, fluorescence will occur from the monomer form with the molecules residing in the grooves in an ordered way with the interacting species kept apart. When pressure is applied to the document of value over the fluorescent region, the alignment of the liquid crystals is temporarily disrupted and the ratio of the excimer formation will change, such that the visual fluorescence properties will change.

Lumiphores can also be used as the active substance with the luminescent properties changing dependent on the polarity of the polymer in which the lumiphore is dispersed. Application of pressure can be used to change the polarity of the material within which the lumiphore is dispersed, and so change the polarity of the lumiphore and alter the radiation emission characteristics. Piezoelectric polymers can be used in a similar way.

Another embodiment relying on pressure to alter the emitted radiation is shown in FIG. 5. A document of value 10 has a thin compressible layer 28 applied to it, with the layer 28 containing a UV filter. Under illumination by ultraviolet radiation, no luminescence is seen as the filter 28 prevents ultraviolet radiation stimulating the active substance contained within or on the document of value 10. When pressure 18 is applied to the document of value 10, the layer 28 thins at the point 30 where pressure is applied, allowing ultraviolet radiation to penetrate the filter and so stimulate the active substance to emit radiation, so altering or making visible an image of the document. Once the pressure is removed, the layer 28 will gradually relax and return to a constant thickness and as it does so the emitted radiation will diminish and eventually disappear. Such a system is fully reversible given a flexible restorable filter layer 28.

One specific way of achieving the embodiment described in FIG. 5 is discussed later in detail in relation to worked examples 1 and 2. In examples 1 and 2, a lumiphore coating is applied to a polymer substrate, such as a PET film, or direct to polymer or paper forming a document of value, with a flexible polymer layer based on poly(urethane) and which contains a UV filter or blocker applied over the lumiphore coating. Under UV irradiation, applying tactile pressure to the flexible polymer layer thins the UV filter within the layer sufficiently to allow UV radiation to reach the lumiphore coating and for luminescence to occur, so changing the image or colours visible to the user. After removal of pressure, the polymer layer restores to a constant thickness, with the UV filter then preventing UV radiation from reaching the lumiphore, and so preventing luminescence. Thus under UV radiation with no pressure, the document of value has one appearance, with this appearance altering as pressure is applied and the lumiphore luminescence becomes visible.

If required, the flexible polymer coating which incorporates the UV filter can also incorporate a lumiphore, such that the first lumiphore coating, which of course may also be incorporated within the document of value by being placed within printing ink and the like, is overlain by a second lumiphore incorporated in a layer which also has a UV filter and is flexible. Under UV irradiation, the document of value will have visible characteristics at least in part dependent on the luminescence of the second lumiphore whose luminescence is not blocked by the UV filter within the same layer. UV irradiation of the first lumiphore beneath this layer will be blocked by the UV filter. As pressure is applied under UV irradiation, the flexible layer will thin in and around the region where pressure is applied, allowing UV radiation to reach the first lumiphore which then emits radiation in combination with the second lumiphore. The resulting appearance of the document of value will then be dependent on the luminescent properties of both lumiphores. If desired, the UV filter and lumiphore in the second coating can be the same substance, i.e. a lumiphore which is also a UV filter.

A similar effect to the embodiment of FIG. 5 can be achieved by using an ultraviolet absorbing compound within an encapsulated gel patch. The patch comprises a robust flexible compressible polymer which encapsulates a gel flowable under applied tactile pressure. The gel contains an ultraviolet filter preventing UV radiation from being transmitted through the gel. The patch is adhered to part of the document of value 10, the document of value containing the active substance, typically incorporated within a paper substrate in the form of ink, fibres, strands, embedded thread, windowed thread or tape, such that at least part of the patch covers at least part of the region where the active substance resides. When the document of value is exposed to ultraviolet radiation, the gel absorbs ultraviolet radiation. When the patch is pressed, the gel flows and moves such that its thickness in the region where pressure is applied becomes negligible and UV radiation transmitted through the patch is able to stimulate the active substance such that the fluorescence can be seen through at least a portion of the patch. In this way a change in image occurs as the gel patch is depressed by a finger or the like. Particularly preferred materials for absorbing the UV and incorporating into a poly(urethane) gel are 4-dimethylaminobenzaldehyde and 2,5-Dihydroxybenzaldehyde.

Examples of preferred UV absorbers are as follows:

Riboflavin

Coumarin 30

9,10-diphenylanthracene

Anthracene

1,6-diphenylhexatriene

Auramine O

Vitamin B12

Coumarin 1

4,6-diamidino-2-phenylindole

Piroxicam

POPOP

Quinine sulphate

1,4-diphenylbutadiene

Azobenzene

Hematin

Bacteriochlorophyll a

Avobenzone(Butyl Methoxy dibenzoyl methane)

Benzophenone-9

3-Benzylidenebornan-2-one

Cinoxate(2-Ethoxyethyl p-methoxycinnamate)

1-p-Cumenyl-3-phenylpropoane-1,3-dione

Digalloyl trioleate

Dihydroxyacetone

2,5-Dihydroxybenzaldehyde

Dioxybenzone(Benzophenone-3)

Ensulizole

2-Ethyl 4-bis(hydroxypropyl)aminobenzoate

2-Ethylhexyl 2-cyano-3,3-diphenylacrylate

Glyceryl aminobenzoate

Homosalate(Homomethyl salicylate)

3-(Imidazol-4-yl)acrylic acid and its ethyl ester

Isopentenyl-4-methoxycinnamate

4-Isopropylbenzyl salicylate

Lawsome with dihydroxyacetate

Menthyl anthranilate(Meradimate)

4-Methylbenzylidene camphor

4-dimenthylaminobenzaldehyde

1,8-bis(dimethylamino)naphthalene

Mexenone

Mexoryl XL

N,N,N-trimethyl-4-(2-oxoborn-3-ylidenemethyl)anilinium methyl sulphate

Neo Heliopan AP

Octocrylene

Octyl methoxycinnamate (Octinoxate, Ethylhexyl p-methoxycinnamate)

Octyl saicylate(2-Ethylhexyl salicylate)

Alpha-(2-oxoborn-3-ylidene)toluene-4-sulfonic acid

Oxybenzone

Padimate A

Padimate O

p-Aminobenzoic acid

Sulisobenzone

Tinosorb M

Tinosorb S

Titanium dioxide

Trolamine salicylate

UVasorb HEB

UVinul A Plus

UVinul T150

Zinc oxide

These substances are absorbers of ultraviolet radiation, generally with a large extinction coefficient in the ultraviolet range. Particularly preferred is 4-dimethylaminobenzaldehyde with λmax of 342 nm and an extinction coefficient of 29,800 M⁻¹ cm⁻¹ and 2.5-Dihydroxybenzaldehyde with λmax of 363 nm.

In a similar manner to FIG. 5, a polymer layer is used in another embodiment to exclude molecular oxygen from reaching a phosphorescent dye incorporated in or associated with a document of value. Applying pressure to the layer reduces its thickness in a similar way as shown in FIG. 5 and allows oxygen to reach the dye and quench emission, and so alter the visual appearance of the image. Relaxation of the layer back to the original thickness, which will occur within minutes and ideally within seconds, restores the equilibrium of the system. One can incorporate phosphorescent and fluorescent substances together in the document of value, with the fluorescent emission obscured or contaminated by the phosphorescence. Pressure allows oxygen through the barrier, quenching the phosphorescence, but the fluorescence is not quenched by oxygen so the perceived colour of the emitted radiation will change under ultraviolet radiation as the pressure is applied. Relaxation of the layer back to the original thickness, which will occur within 5-10 minutes and ideally within seconds, restores the equilibrium system.

Where layers are added to the document of value, for example protective layers or layers containing filters and the like, the overall thickness of the document with all layers should not exceed 1 to 150 microns, and more preferably be in the range 80 to 120 microns.

In all the above examples, the alterations in appearance only occur with application of pressure and are completely reversible such that removal of pressure results in the active substances reverting to their initial state from their altered state.

The above embodiments of the invention provide a banknote security feature that is used to distinguish visually between genuine and counterfeit banknotes and depending on the properties of the active substance is detectable with the existing ultraviolet lamps which emit ultraviolet over a broad spectrum, with strong emission at 365 nm.

Typically, the image change seen for all embodiments of the invention will fall within the visible range 400-700 nm and be stimulated in response to UV radiation. The image can change from colourless to visible, or from visible to colourless, or change in colour by alterations in the wavelength emitted. Where the active substance changes its emission from one visible wavelength to another visible wavelength, colour shifts of, for example blue and on pressure to red, green on pressure to red, yellow on pressure to red, or in reverse alternative combinations may be used. Depending on the embodiment concerned, initial images may be red, yellow, green or blue and then switch to colourless. Alternatively the reverse may be seen, for example the image changing from colourless on pressure to be red, yellow, green or blue.

Specific implementations of the embodiment described generally in relation to FIG. 5 will now be described in more detail by way of example.

### EXAMPLE 1

To prepare a pressure-responsive feature for use on a document of value, a coating containing a lumiphore excited by radiation of around 365 nm was applied to a PET film and coated with a flexible polymer incorporating a UV absorber or blocker. The chosen polymer was poly(urethane) which was synthesised in the following way using a pre-cursor diol.

Firstly poly(caprolactone)diol was synthesised by adding a mixture of caprolactone (1 mole, 114.0 g) and butanediol (0.11 mole, 10.0 g) to a two necked round bottom flask fitted with a condenser. The mixture was heated at 130° C. overnight under a nitrogen atmosphere in the presence of dibutyltin dilaurate as a catalyst. This produced poly(caprolactone)diol as a solid at room temperature with a molecular weight of 1200 gmol⁻¹, determined by size exclusion chromatography in Tetrahydrofuran (THF). The poly(caprolactone)diol (30.01 g, 70% of the total) was then added to a pre-heated reactor equipped with mechanical stirrer at 90° C. under nitrogen atmosphere. The reactor was allowed to heat at the same temperature for 30 minutes and then the temperature reduced to 40° C. 2 to 3 drops of dibutyltin dilaurate as a catalyst and isophorone diisocyanate (IPDI) (10.78 g) were added respectively. The reaction temperature was maintained at 50° C. to avoid gel formation and stirred for 90 minutes. Then a solvent mixture (Dimethyl sulphoxide (DMSO) and methylisobutylketone (MIBK) in the ratio 1:2, (DMSO=6.81 g and MIBK=13.59 g; 50% of the total) was added. The reaction mixture was stirred at 50° C. for another hour and then samples were collected for titration. The moles of free NCO left in the whole reaction mixture were calculated by titration using 1N HCl in methanol and 1N dibutyl amine in toluene.

This achieved synthesis of poly(urethane) via step growth polymerisation according to the following equation where:

$$Soft segment content = \frac{{W}_{s}}{{W}_{s} + {W}_{i} + [ \frac{{W}_{i}}{{M}_{i}} - \frac{{W}_{s}}{{M}_{n}} ] {M}_{d}}$$

Where M_{d}=molar mass of diol, Mₛ=mass of soft segment (PCL) and Mₙ=number average molecular weight of polycaprolactone (PCL).

Soft segment, PCL=70%=30.01 g

Using above equation, Wᵢ(IPDI)=10.75 g

(Moles of NCO=0.0967, Moles of OH=0.05)

A stoichiometric quantity of 1,4-butane diol was added to the reaction mixture to react with all remaining NCO groups and the reaction mixture was allowed to heat at 50° C. for two hours. Another set of samples was collected and titrated following the procedure described above. The amount of free NCO should then be 0. The reaction mixture was allowed to heat at the same temperature for another hour, leaving crude poly(urethane). Around 10 g of crude poly(urethane) was taken and washed with methanol 10-15 times and then immersed in isopropyl alcohol for 24 hours. Poly(urethane) was dried at 40° C. under vacuum oven and pure poly(urethane) obtained.

Following manufacture of the pure poly(urethane)polymer, a lumiphore coating solution and a polymer/UV absorber coating solution were prepared. The first coating solution of the lumiphore was obtained by mixing 2.5 g of 20% poly(methyl methacrylate) (PMMA) solution in dichloromethane (DCM) (w/w) with 0.5 ml of lumiphore solution (38 mg/cm³ of lumiphore in DCM). Typically the lumiphore was selected to exhibit green radiation under UV irradiation, although lumiphores emitting radiation corresponding to other colours can be chosen. The second polymer/UV absorber coating solution was obtained by mixing 0.5 g of 20% poly(urethane) solution in DCM (w/w) with 1 ml of benzophenone solution (250 mg/cm³ in DCM), benzophenone being a UV filter or blocker.

The two coatings were then applied to a PET film so as to confirm that the coatings acted in accordance with the present invention. Coatings applied to such a PET film can either be applied to a document of value direct or else to the PET film with the combination of PET film and 2 coatings forming a patch which is then applied to a document of value.

The PET film was firstly coated with the first coating solution using hand coaters, also known as K bars, to give a wet film thickness of 4 μm and then allowed to dry. The coated PET film was then coated with the second UV absorber coating using a hand coater to give a wet film thickness of 50 μm. The coated PET film was allowed to dry at room temperature, such that the PET film then had a first coating containing the total coating lumiphore and a second flexible coating containing the UV blocker, the overall thickness being around 10 μm. Under UV irradiation with no pressure applied, no fluorescence could be observed.

After application of finger pressure under UV irradiation, fluorescence from the first coating was seen. This was because the second coating had thinned around the region where pressure was applied to a thickness of between 8 to 0.5 μm and as the finger was removed, the thinned region of the second coating no longer blocked all UV from reaching the lumiphore layer. The emission from the lumiphore layer could thus be seen in the region where pressure had been applied. After removal of tactile pressure, the flexible second coating gradually relaxed back to an even thickness, then blocking all UV radiation from reaching the first coating and so switching off fluorescence.

Thus by selecting an appropriate UV blocker and combining it with a flexible polymer, a lumiphore can be coated with a layer which flexes and thins sufficiently on application of finger pressure to allow UV light to reach the lumiphore and so allow the lumiphore to alter its visible characteristics. If required, additional softeners are added to the polymer to ensure it retains its flexibility over prolonged periods of time, typically the lifetime of a document of value.

### EXAMPLE 2

A number of substituted benzaldehydes were found to filter out UV radiation around 365 nm and so act as UV filters or blockers. 2,5-Dihydroxybenzaldehyde has an absorption maximum of 363 nm in methanol (MeOH) and is a cross-linking reagent for the poly(urethane) prepolymer due to the presence of two hydroxy groups. The covalent attachment of the UV filter to the polymer prevents possible migration of the UV filter from the polymer.

In this second example, poly(urethane) was synthesised by heating poly(caprolactone diol) (M.N. 2000, 8 g) to 80° C. and degassed under vacuum. Following cooling to room temperature, dibutyltin dilaureate (4 drops) and THF (dry, 20 cm³) were added. Isophorone diisocyanate (3.2 g, 14.4 mmol) was added dropwise via a pressure-equalising dropping funnel. The reaction was heated to 60° C. and 2,5-dihydroxybenzaldehyde (3 g, 21.7 mmol) was added and left to stir at this temperature overnight. Diisooctylphthalate (5 cm³) was added and left to react for a further 2 hours. The reaction was cooled to room temperature and THF was removed in vacuo. The polymer was washed with MeOH and propylalcohol (ⁱPrOH) to give a pale green gelatinous polymer. Thus preparation of the poly(urethane) in the presence of diissooctylphthalate was found to result in a soft gelatinous material, following end-capping with the substituted benzaldehyde.

This polycaprolactone-based polymer (250 mg) was mixed thoroughly with a Gel Cast Shore Hardness 5 poly(urethane) to give a polymer mixture with an integral UV filter.

A lumiphore coating was prepared by dissolving lumiphore (2g) in THF (8 cm³) and mixed with 10 g of 10% w/w PMMA in dichloroethane so as to give a first coating in the form of a fluorophore-polymer mixture. As with example 1, typically a lumiphore is chosen which emits in the green part of the visible spectrum under UV irradiation, although other lumiphores can be used.

The lumiphore coating was applied to optically dull paper and left to dry overnight. The polymer mixture was then applied to the paper, and over the lumiphore coating, using a hand coater and allowed to set for 1 hour. Under UV irradiation, the resulting bilayer system could be compressed using finger pressure to reveal the fluorescence from the layer beneath. The poly(urethane) layer relaxed back within a few minutes after removal of pressure to prevent fluorescence.

1. A security document bearing an image associated with an active substance, wherein the active substance is responsive to pressure to temporarily alter the appearance of the image when viewed under synthetic radiation.

2. A security document according to claim 1, wherein the synthetic radiation is broad spectrum ultraviolet radiation.

3. A security document according to claim 1, wherein the active substance is responsive to pressure to alter the appearance of the image for 5 minutes to 0.1 seconds.

4. A security document according to claim 3, wherein the active substance is responsive to pressure to alter the appearance of the image for 60 seconds to 1 second.

5. A security document according to claim 1, wherein the active substance emits radiation and is responsive to pressure to change the wavelength of the emitted radiation.

6. A security document according to claim 1, wherein the active substance is responsive to tactile pressure applied by a human finger or thumb.

7. A security document according to claim 1, wherein the active substance is incorporated in an ink forming at least part of the image.

8. A security document according to claim 1, further comprising a substrate and wherein the active substance is incorporated in the substrate.

9. A security document according to claim 1, further comprising a substrate wherein the active substance is incorporated in a patch applied to the substrate.

10. A security document according to claim 1, wherein the active substance is dispersed in a polymer, thixotropic material or adhesive.

11. A security document according to claim 1, wherein the active substance is incorporated in fibres, strands, embedded thread, windowed thread, or tape within a substrate.

12. A security document according to claim 1, wherein a compressible layer is associated with the active substance, the active substance responsive to compression of the layer to alter the appearance of the image.

13. A security document according to claim 12, wherein the compressible layer is a patch encapsulating a flowable substance.

14. A security document according to claim 12, wherein the active substance is associated with one layer disposed above a substrate.

15. A security document according to claim 1, wherein the active substance is associated with two, three or more communicating layers disposed above a substrate.

16. A security document according to claim 15, wherein at least one layer incorporates a UV filter capable of being rendered inoperative in response to pressure.

17. A security document according to claim 1, wherein the active substance comprises at least one of the following:
organic or inorganic dye or dyes, chromophore(s), multi-chromophore(s), lumiphore(s).

18. A security document according to claim 1, wherein the active substance is able to form excimers and is responsive to pressure to alter the number of excimers.

19. A security document, comprising:
a substrate;
an image supported by the substrate; and
means responsive to pressure for temporarily altering the appearance of the image when viewed under synthetic radiation.
